(19) United States
(12) Patent Application Publication
(10) Pub. No.: US 2012/0239583 A1
(43) Pub. Date: Sep. 20, 2012

(54) METHOD AND SYSTEM FOR COMPUTERIZED TRACKING, ANALYZING AND REPORTING OF INFORMATION SPECIFIC TO RESIDENTIAL AND COMMERCIAL TENANCY HISTORIES

(76) Inventor: John M. Dobrowolski, Toronto (CA)

(21) Appl. No.: 13/285,478

(22) Filed: Oct. 31, 2011

Related U.S. Application Data
(60) Provisional application No. 61/452,729, filed on Mar. 15, 2011.

(51) Int. Cl. G06Q 99/00

(52) U.S. Cl. 705/307

(57) ABSTRACT

A method and system for collecting, tracking, analyzing and reporting tenancy histories is provided along with a rent score and application adjudication process for assessing new tenancies. A tenancy history is complied for each tenancy life cycle (approval, move-in, move-out) for all manner of tenancies residential and commercial. A rent scoring model employs a tenancy scorecard of all events experienced between a landlord and tenant. On demand, a tenant's history data is analyzed to present a snap shot of the present status of a tenant considering all historical events. A landlord's report may include particulars of monthly tenancy payments, legal matters, sheriff enforcement, collection and real-time rent scoring. Optionally the rent score may be combined with certain credit information to create a comprehensive standing. The model may consider other factors relating to tenancy history such as, acceptance rating, evictions, collections, employment, income and expenses, and other rental property management information.

### CROSS-REFERENCE

This application claims the benefit of U.S. Provisional patent application No. 61/452,729 filed Mar. 15, 2011.

### COPYRIGHT RESERVATION

Portions of the disclosure including certain figures and/or tables herein contain material, which is subject to copyright protection. The copyright owner has no objection to the lawful facsimile reproduction of the patent document or the patent disclosure, as it appears in the Patent and Trademark Office patent files or records, but otherwise reserves all copyright rights whatsoever.

### TECHNICAL FIELD

The present disclosure relates to tenancy property management including tenancy application adjudication and more particularly to methods and systems for compiling and maintaining tenancy history data and computing and utilizing a score with which to perform adjudication.

### BACKGROUND

When compared to the myriad of management tools used by the credit granting industry rental property businesses lack such similar system tools specifically designed to manage the credit of granting tenancies. The tool of choice is credit reports when selecting tenancy applicants. The integrating of payment history for loans and credit in general, and delinquencies creates the basis for credit scoring models found in credit information from credit bureaus. Since landlords presently use credit reports during adjudication of tenancy applications it is clear that this is a flawed system and misrepresents the true measure of tenancy worthiness for a consumer who is a renter.

After a long study of court records, empirical evidence shows that only a fraction of the applications for eviction by landlords result in enforcement by the Sheriff and in fact the outcome is less than one (1%) percent of the tenants brought before a Judge or Adjudicator actually get evicted. The large majority of tenants are in good standing throughout their rent life. This is an underlying and core finding derived from over 20 years of studying eviction records, which has defined the premise that good standing tenancy records vastly outnumber negative tenancy events.

The major events in the life cycle of a tenancy that apply to each successive rental property are simple, apply, move in, and move out as depicted in FIG. 1. The various experiences that occur along the way are categorized herein and establish a set of core real life events that are analyzed, scored and weighted using individual data tables to create standard tenancy ratings, and rent scoring.

Today as in the past landlords have made use of consumer reporting agencies and their credit ratings such as R1-R9 and a variety of credit scoring tools to attempt to evaluate the worthiness of a prospective tenancy applicant, however the credit criterion used in a credit scoring model is based solely on credit history. Credit bureaus have ignored and indeed excluded integrating tenancy payment history into such a model thereby creating inadequate selection decisions and poor risk management. Moreover the status quo fails to provide the tenancy grantor's (landlords) industry with a specific landlord's tenancy report to accurately screen prospective tenancy applicants.

### SUMMARY

A method and system for collecting, tracking, analyzing and reporting tenancy histories is provided along with a rent score and application adjudication process for assessing new tenancies. A tenancy history data is compiled for each tenancy life cycle (approval, move-in, move-out) for all manner of tenancies residential and commercial. A rent scoring model employs a tenancy scorecard of all events experienced between a landlord and tenant. On demand, tenant's tenancy history data is analyzed to present a snap shot of the present status of a tenant considering all historical events. A landlord's report may include particulars of monthly tenancy rent (and/or other) payments, legal matters, sheriff enforcement, collection and real-time rent scoring. Optionally the rent score may be combined with certain credit information to create a comprehensive standing. The model may consider other factors relating to tenancy such as, acceptance rating, evictions, collections, employment, income and expenses, and other rental property management information.

The method herein devised produces a true landlord's report a product that encompasses only relevant information for landlords and does not blend together credit history with tenancy history. This is the problem that landlords are faced with and the core issue at play tenancy history and paying habits of tenants, eviction and other tenancy termination events are excluded from credit scoring algorithms that have been refined over decades that rate the best credit risk with a rating of one (1) equates to a consumer paying within 30 days or not more than one (1) payment past due. In the world of renting property this is absurd; as rent must be paid in advance on the due date usually the first (1st) of the month. The problem is further exasperated when such data is rolled into a credit score where the resultant high score would skew the reality of what a renter's risk really is since the scoring like the rating in the credit world works well when a consumer pays within thirty (30) days. Accepting this criterion as reliable in a rental property business is where it fails significantly.

The rent scoring formulae, unlike credit scoring, utilizes only tenancy history, including monthly payment obligations, termination and eviction history to determine a rental score for renters that bases its scoring algorithm on tenancy events that are assigned a tenancy rating such as: one (1) representing a payment within five (5) days of the payment due date or not more than one (1) payment past due. Other tenancy performance parameters may also be factors as discussed further herein below.

### BRIEF DESCRIPTION OF FIGURES

FIG. 1 depicts the life cycle of a tenancy's major events.

FIG. 2 depicts the rent scoring model and relationship to input and output data.

FIG. 3 shows a graphical representation of eviction event data in accordance with a computational formula.

FIG. 4 shows an example of the raw data used from one tenancy record.

FIG. 5 shows an example of how the full compliment of tenancy life cycle data can be formatted in a landlord's report;

FIG. 6 illustrates an example network communication system including property management client computers and a tenancy history collection and rent score server system;

FIGS. 7A and 7B illustrate components of an example tenancy history collection and rent score server system;

FIG. 8 is a flowchart illustrating operations of the tenancy history collection and rent score server system for processing a new tenancy application including providing a rent score;

FIG. 9 is a flowchart illustrating operations of the tenancy history collection and rent score server system for receiving tenancy history data from a property management client computer;

FIG. 10 is a flowchart illustrating operations of the tenancy history collection and rent score server system for automatically updating certain tenancy history data; and

FIG. 11 is a flowchart illustrating operations of the tenancy history collection and rent score server system for calculating rent score for a particular tenant.

### DETAILED DESCRIPTION

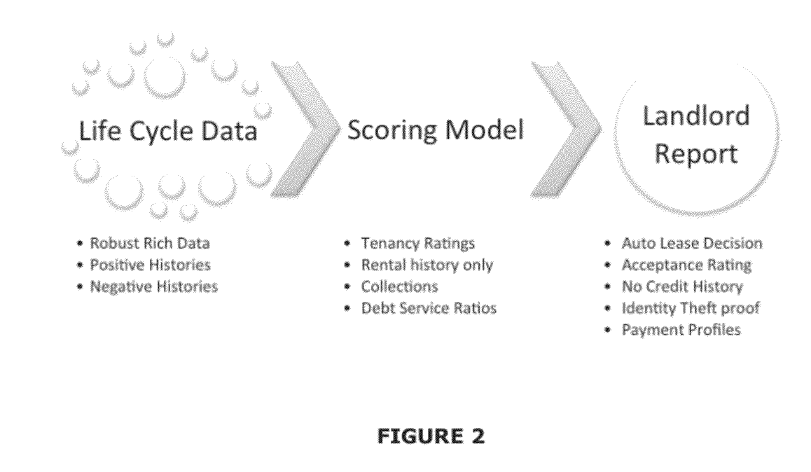

FIG. 2 depicts an informational workflow in accordance with an embodiment of the invention. The workflow is schematically defined by three main phases: Life Cycle Data (a tenancy history data compiling or collection phase), Scoring Model (a computational phase to determine a rent score from tenancy history data for a particular tenant and to perform tenancy application adjudication as further described), and Landlord Report (a reporting and information dissemination phase). Each phase of such workflow may be assisted by computer implementation. In addition to the creation of a rent scoring program method and business model, workflow may include the automatic generation of a report and property management documents such as leases and the like.

It is also understood that in practice, the phases are performed concurrently for a multiplicity of tenancy applications. Life cycle data collection is on going. Further, the rent score computation and adjudication determined for a prospective applicant for tenancy from tenancy history data compiled for that applicant is performed for given life cycle data available at the time.

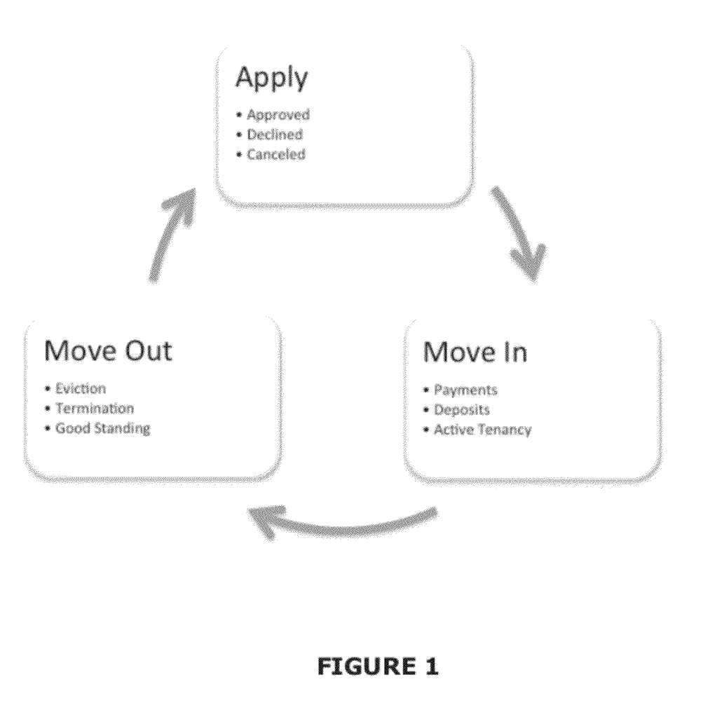

The rent score model and program utilizes tenancy life cycle (see FIG. 1) history information represented by data submitted in various ways by participating contributors. Relying on data submissions from landlords about individual tenants, information pertaining to payment and termination history is collected regularly. Tenancy application data and adjudication results in addition to other tenancy history, for example, manner of payment and move in/move out information, vary in frequency of collection for each particular tenancy from daily to monthly depending on submission method.

The major events of a tenancy life cycle are 1. Apply, 2. Move In, 3. Move Out as in FIG. 1. A tenancy may experience many of the following events; application processing data, good standings monthly records, payment defaults, legal proceeding commencement (like serving termination notices), judicial decisions handed down (including various settlement and mediated matters), enforcement of judgments for garnishment, eviction and collections. Upon vacating, information as to move out status and reason is collected.

Tenancy history data is broadly a description of all the data that is tracked for a tenant. Tenancy history data may include tenancy history payment data, termination history data, and other performance data as well as any additional related data for a particular tenancy life cycle such as move in date, payment period, move out date, particular property, etc.

The rent scoring method and program employs a specially designed rating system including ratings from 0-9 that relate to tenancy events as in Table 1. When starting a new tenancy a rating of zero (0) results because not enough history exists to rate the resident. The account type “O” refers to “Open” or “Other” account since the value may change due to periodic rent increases, and adjustments and does not mix with standard financial credit reporting account types.

TABLE 1
Tenancy Rating (Rt) Classification

| | | Account | |
|---|---|---|---|
| Category | Rating | Type | Description |
| Good | 0 | O | Too New |
| Standing | 1 | O | Excellent |
| Payment | 2 | O | Arrears on regular housing charges, |
| Default | 3 | O | such as; Rent, Utilities, Security, |
| | 4 | O | Parking, Amenities, and various |
| | 5 | O | Deposits. |
| Legal Action | 6 | O | Notices, Filings |
| Judicial | 7 | O | Settlement |
| Decisions | 8 | O | Eviction |
| Enforcement | 9 | O | Bad Debt, Collection |

0—Not moved in yet, too new to rate or not enough information to rate
1—On Time or Satisfactory Payment pays within 5 days of Due date
2—Pays (or paid) within 6 to 30 days or not more than 1 payment past due
3—Pays (or paid) within 31 to 60 days or not more than 2 payments past due
4—Pays (or paid) within 61 to 90 days or, 3 or more payments past due
5—Pays (or paid) within 91 to 120 days but no action filed yet
6—Legal Action to terminate tenancy commenced, notice served or legal action filed
7—Making payments under ordered consent or mediated settlement
8—Eviction Ordered by judicial decision
9—Sheriffs Enforcement, Bad Debt, placed in Collection, skipped

The tenancy history data of Table 1 may be grouped in various ways. For example, Good Standing and Payment Default events and ratings may be grouped as tenancy history payment data. Legal Action and Judicial Decisions may be grouped as termination history data. Enforcement events may comprise one of the other performance data. Enforcement events relate to judicial enforcement of bad debts. These may run post termination or even without termination (i.e. landlord receives judgment against tenant for payment but lease is not terminated). Further other performance factors which may be collected and analyzed as other performance data for calculating a rent score may include tenancy application adjudication results, tenant income and income to rent and/or income to total payments ratios, bankruptcy events, etc.

The rent scoring model and program utilize outcome information from the tenancy application selection process conducted by a landlord or agent, and a tenancy history tracking system where history data collected comprises from initial applicant screening, to move in up until move out. A description of move out status and reason is captured (e.g. for compiling as termination history data) to inform the system of the circumstances surrounding the end of a tenancy and better understand this life cycle event when aggregate statistics are studied.

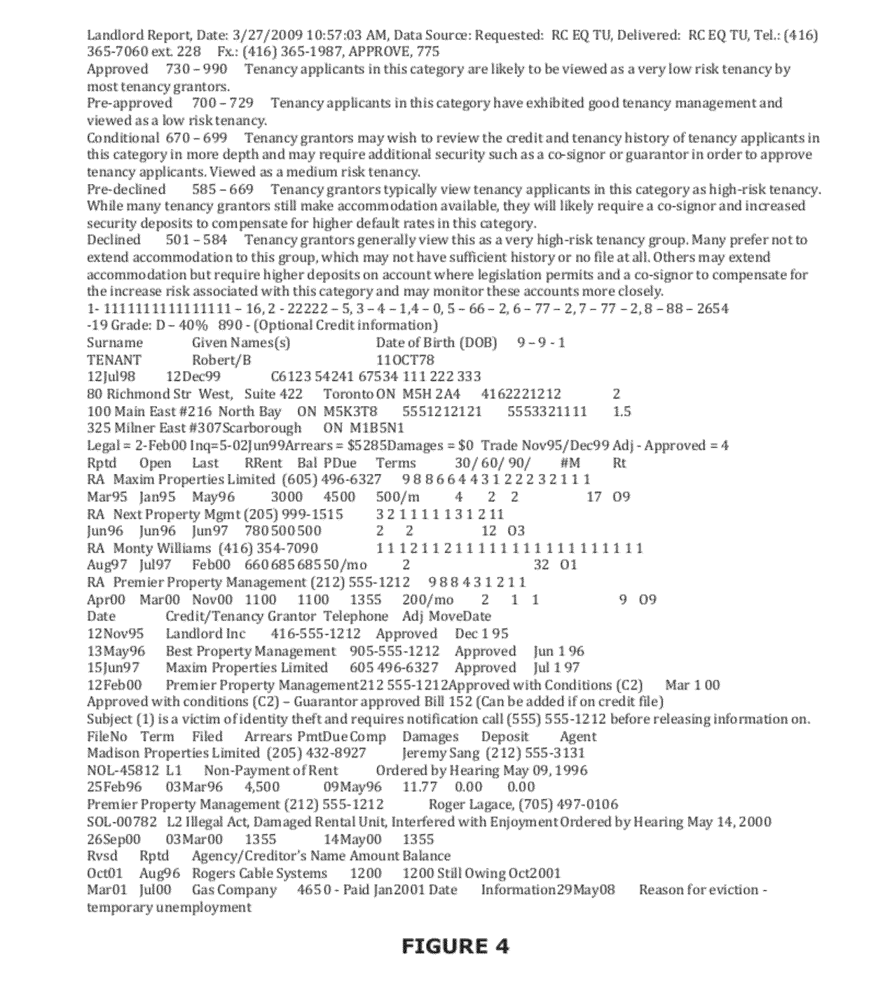

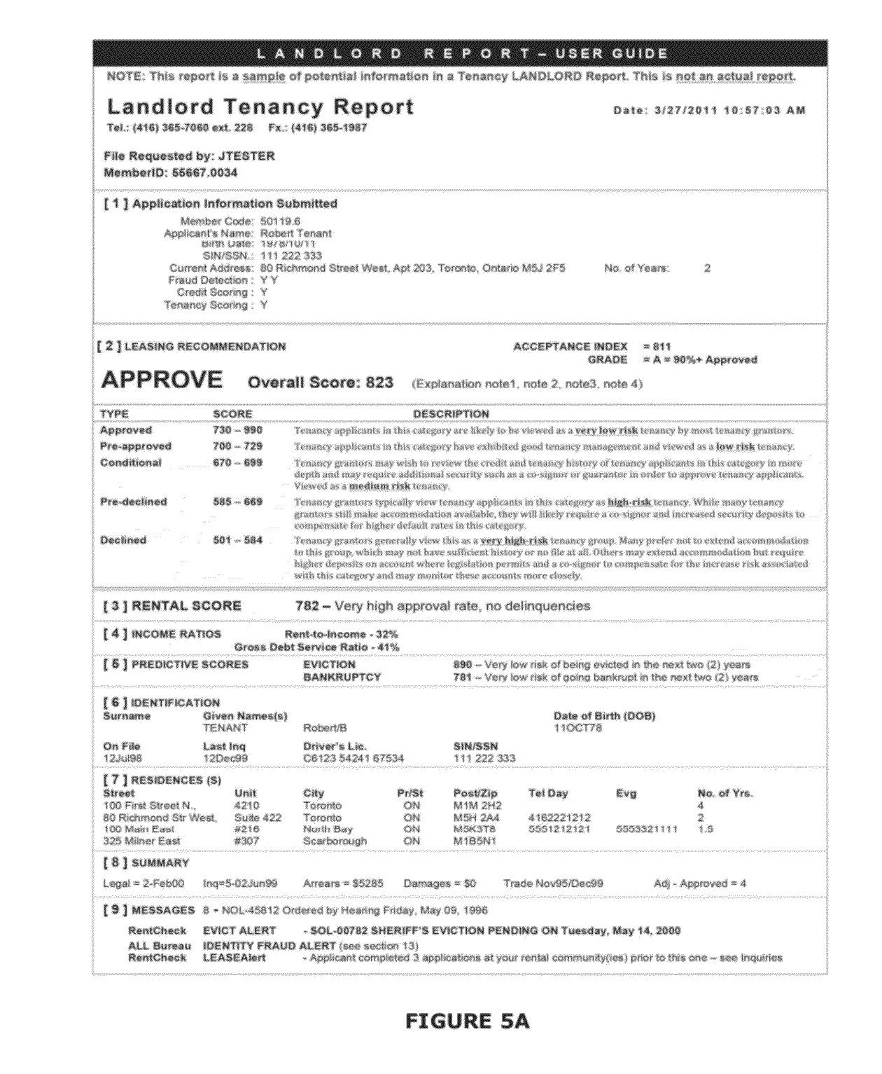

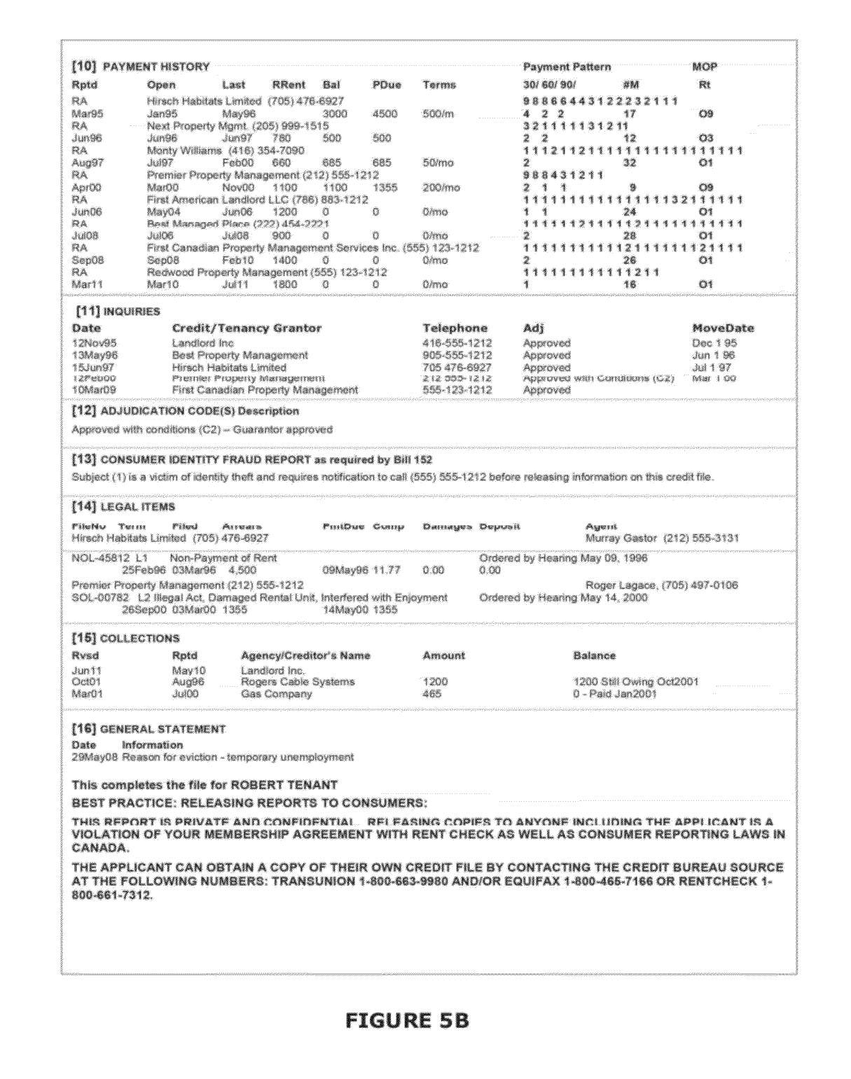

An example of the resultant unformatted information collected is depicted in FIG. 4 and formatted in a sample report as in FIGS. 5A and 5B.

To successfully compute a rent score for a particular tenant, it is necessary that the rent scoring model access a robust volume of positive and negative tenancy history data that reflects the manner in which a tenant makes payment obligations throughout the tenancy life cycle.

To assist with data collection, new tenancy application adjudication requests through the system may be used as a trigger to initiate tenancy history data collection for a tenant in association with a particular property. For example, a tenancy search or a search that results in a new application being approved or approved with conditions through the adjudication system may be used to facilitate data collection automatically or at least semi-automatically. The establishment of a newly approved (or approved with conditions) application may be a trigger to start the automated collection system for the particular life cycle. Using the collected move in date and payment period, the automated collection system may be configured to collect tenancy history payment data. For example, every 6^{th} day after the payment due date, in each payment period commencing the first month of tenancy, the automated collection system may operate to collect payment history data, for example, prompting entry of payment data and/or confirmation of automatically entered payment data. When payment obligations are reported as confirmed paid within 5 days, the resultant rating is a “1”: the best tenancy rating. When considering payment defaults the next four ratings account for late payment. When rent is late six days and less than 30 a rating of two “2” results, a rating of “3” when 31-60 days late, a rating of “4” when 61-90 days late, and a rating of “5” when 91-120 days late. Whenever a termination notice or any other notice pertaining to a lease violation is served to the tenant by the landlord, a rating of “6” is assigned. The occurrence of a judicial decision relating to settlements and mediation excluding eviction are assigned a rating of “7”. Judicial decisions for eviction are rated as “8” and tenancies that result with debts owing are rated “9”. In accounting terms a tenancy account is an open account and is denoted as account type “O”. The rating classifications are listed in Table 1.

Another component of the rent scoring model is a customizable move out status and reason list as below designed to close the loop of the tenancy events life cycle (termination history data).

TABLE 2
MoveOut Reference

| | Vacate Status | | |
|---|---|---|---|
| Vacate Reason | Description | Reference | Grade |
| School term ended | Always paid on time | Excellent | A |
| Purchased a house | Broke lease with proper | Good | B |
| | notice | | |
| Death of tenant | Broke lease without | Satisfactory | C |
| | notice | | |
| Debt pursuit | Could not ask for a | Average | D |
| abandoned | better tenant | | |
| Employer paid | Default due to job loss | Satisfactory | C |
| termination | | | |
| Left due to job | Excellent standing | Excellent | E |
| relocation | | | |
| Left to live with | Good standing | Good | F |
| family | | | |
| Past two year | Great tenant very | Excellent | A |
| limitation | respectable | | |
| Other | Persistently late rent | Unsatisfactory | E |
| | payments | | |
| | Tenant damages | Unsatisfactory | E |
| | Would not rent to this | Poor | F |
| | person | | |
| | Written off as bad debt | Poor | F |
| | Other | | |

A Payment Period is a specific length of time; such as, weekly, bi-weekly or monthly that the rent payment is made in advance. These payments may include other charges, such as, deposits for security, pets, and damage not included in the regular rent payment. The rent scoring system requires knowledge of leasing adjudication results to determine acceptance and move in date. With this information and the payment period, a tenancy history data collection may be initiated for the particular tenant.

In accordance with an embodiment, the adjudication of a new tenancy application is used to trigger tenancy history collection. To determine which records to track, a method was devised that imposes the entry of adjudication decisions reporting: the rental property users report their adjudication as to whether they approved, pre-approved, conditionally approved, pre-declined or declined the prospective tenant for each open or pending application in the system. By knowing which renter applicant was approved the method to continue and track rental payments and other tenancy history for a particular applicant can now begin.

Adjudication reporting is a function of the rent scoring methodology that establishes the start of the landlord's relationship with a renter. The very first step for a renter who is seeking to rent accommodation is to determine if a selected property is suitable. After a renter's review and deciding where to live a renter needs to complete a rental application form, then if accepted a lease.

Prior to ordering consumer reports the rental property management team uses their internal procedural methods such as requiring and confirming employment letters, and calling the previous landlord, as a preliminary step before continuing to request and make use of a consumer report to review the background of the renter. In accordance with an embodiment, the rent scoring model and method demands that the actual and final decision whether to accept or decline an applicant be captured in the database and is a mandatory requirement as a rent scoring data item. That is, workflow and data capture operations are configured to enforce a subscribing user (e.g. landlord or property management user) to input certain outstanding data such as tenancy application approval results in order to obtain further particular services. For example, should a subscribing user establish an “open” tenancy application/adjudication record for a particular tenant, the final adjudication result taken (e.g. approval, disapproval, etc.) must be entered into the adjudication system before the user may be granted access to further services.

Each adjudication table such as the approved adjudication table is developed with intervals of occurrences set at specific points in time such as 30, 60, 90 days are used to calculate the number of days since the adjudication occurred. The table records the information used to develop a sub-score for adjudication events. Because an individual may apply for tenancy several times, many occurrences of the adjudication event exist. Over time history of several rental properties and approval or disapproval decisions rendered may be collected for the particular tenant. Each occurrence of the adjudication event is assigned points. For example lets assume that today an individual completed a rental application and the resulting adjudication event was decided as approved. As this occurrence happened today and the adjudication event answer was approved the points assigned to this event occurrence for calculating a rent score would be 20. If there existed more historical occurrences of approved adjudication say 853 days ago the assigned points would be 10 and 1605 days ago the points assigned would be 7. The total points for these events would be 37. A time sensitive table of approved adjudication is used to develop the various points assigned for each number of days interval such that as the adjudication event ages over time, the assigned points are aged (in this case the point values decline). For example, 0 days interval equals 20 points, 30 days equals 18 points, 60 days equals 16 points, 90 days equals 15 points, and 180 days equals 13 points etc. is used to determine the points to assign each approval depending how long ago it occurred as denoted in Table 3.

TABLE 3
Adjudication History (Approved)

| Inquiry | | | | | | | | | | | | | | | | | | |
|---|---|---|---|---|---|---|---|---|---|---|---|---|---|---|---|---|---|---|
| Date | | | | | | | | | | | | | | | | | | |
| (Ind) | Number | | | | | | | | | | | | | | | | | |
| (Descending | of | | Quantity Sequence | | | | | | | | | | | | Output Data | | | |
| Date Sort) | Days¹ | Days | 1 | 2 | 3 | 4 | 5 | 6 | 7 | 8 | 9 | 10 | 11 | 12 | x | y | y (fit) | residual |
| 23-Jun-08 | 994 | 0 | 20 | | | | | | | | | | | | 0 | 20 | 17 | 2.60238 |
| 2-Jun-06 | 1746 | 30 | 18 | 16 | | | | | | | | | | | 30 | 18 | 17 | 1.01124 |
| | | 60 | 16 | 15 | 13 | | | | | | | | | | 60 | 16 | 17 | −0.59867 |
| | | 90 | 15 | 13 | 12 | 11 | | | | | | | | | 90 | 15 | 16 | −1.22609 |
| | | 180 | 13 | 12 | 11 | 10 | 9 | | | | | | | | 180 | 13 | 15 | −2.20238 |
| | | 365 | 12 | 11 | 10 | 9 | 8 | 7 | | | | | | | 365 | 12 | 13 | −1.45718 |
| | | 730 | 11 | 10 | 9 | 8 | 7 | 6 | 6 | | | | | | 730 | 11 | 11 | 0.02793 |
| | | 1095 | 10 | 9 | 8 | 7 | 6 | 6 | 5 | 5 | | | | | 1095 | 10 | 9 | 0.73827 |
| | | 1500 | 9 | 8 | 7 | 6 | 6 | 5 | 5 | 4 | 4 | | | | 1500 | 9 | 8 | 1.10399 |
| | | 1865 | 8 | 7 | 6 | 6 | 5 | 5 | 4 | 4 | 3 | 3 | | | 1865 | 8 | 7 | 1.03024 |
| | | 2230 | 7 | 6 | 6 | 5 | 5 | 4 | 4 | 3 | 3 | 3 | 2 | | 2230 | 7 | 6 | 0.76199 |
| | | 2595 | 6 | 6 | 5 | 5 | 4 | 4 | 3 | 3 | 3 | 2 | 2 | 2 | 2595 | 6 | 6 | 0.35469 |
| | | 2960 | 6 | 5 | 5 | 4 | 4 | 3 | 3 | 3 | 2 | 2 | 2 | 2 | 2960 | 6 | 5 | 0.84454 |
| | | 3325 | 5 | 5 | 4 | 4 | 3 | 3 | 3 | 2 | 2 | 2 | 2 | 2 | 3325 | 5 | 5 | 0.25616 |
| | | 3690 | 5 | 4 | 4 | 3 | 3 | 3 | 2 | 2 | 2 | 2 | 2 | 1 | 3690 | 5 | 4 | 0.60691 |

In accordance with one embodiment, the tenancy scorecard further calculates the number of approvals divided by all adjudication events to create an approval rating percent and then applies an approval grade of A, B, C, D, or F and a final acceptance rating is calculated.

The address of each property where the adjudication event occurred is stored and compared to the user landlord's list of properties and a calculation is made to show how many matches exist. An application alert is added to the acceptance rating that indicates the number of applications made by the tenancy applicant at properties owned by the user landlord.

In actuality there could be a great number of multiple occurrences and answers per event than the example above, which take place in a rental property business on a daily basis.

### Formula (1)

An Example of a Computational Formula and Resultant Graphical Characteristic from One (1) of Thirteen (13) Data Tables and Corresponding Non-Linear Least Squares Curve Fitting Computations.

y₁=1/((1/a)+b*x)+c

Where: y=the points for each event data table which represent a sub-score
a, b, c=constants and vary depending on the event

x=Prd−Ind =Time in Days
where: Prd=Present date
   Ind=Inquiry Date

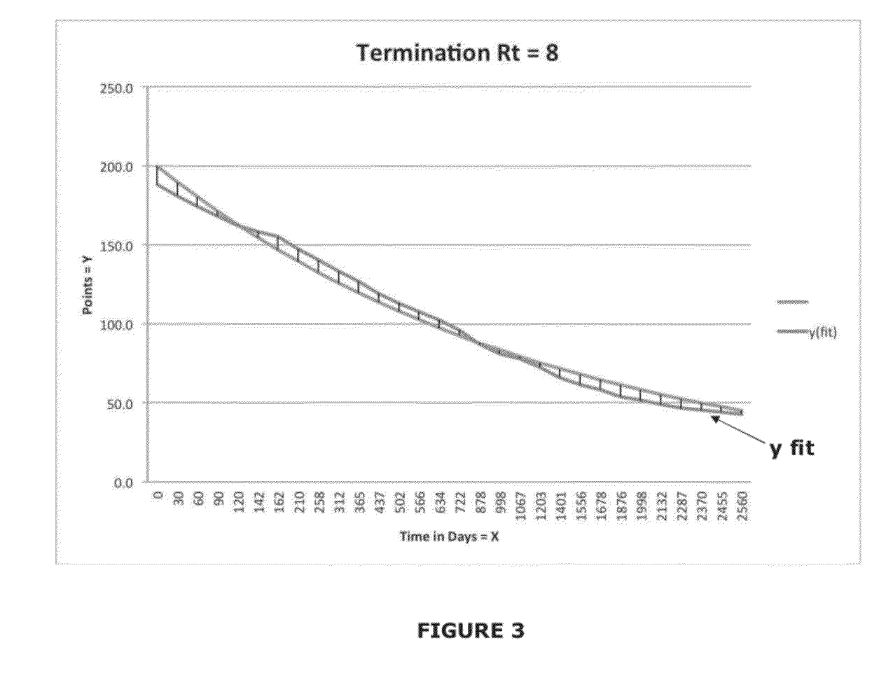

Formula (1) shows the conversion to a formula based on data (Table 3) in this case for approved adjudication event occurrences, which uses a curve fitting formula and constants derived. The resultant formula is graphed (FIG. 3) and produces a proximity curve that represents the formula results (y)fit vs. assigned points from the table (y). The advantage to using a formula are many such as point calculations have a much greater degree of accuracy since any number of days and not just a range between intervals can be input as the x value. Along with specific constants for each event all formulae are calculated and all individual points recorded. Weighting is applied to the events depending on importance, such as; payment history represent 35% of the score, eviction represents 30% of the score. The output data shown above with Table 3 represents the results of the use of Table 3 and the formula as well as the difference between the two. The resulting formula may not exactly match point values assigned via the table method. In some embodiments, a single formula may be used to perform the points allocation for each occurrence of the event. Whereas Table 3 shows points allocations which may differ for each of a 1^{st}, 2^{nd}, 3^{rd} . . . 12^{th} adjudication event over time, a single formula, such as described above, may be used to assign points to any adjudication event, approximating the points allocation assigned in the table method.

As the tenancy scorecard combines all the historical occurrences for each event, and totals the points the scorecard's point total is then compared to an upper and lower score limit. If the total goes below the lower limit no score is provided as there is not enough data on file. If the total is above the upper limit an adjustment is made to show the score is an excellent score but is within the top level upper base maximum of 900.

Finally the rent score can be optionally combined with credit scores to produce a master score that can be customized. Weighting can be applied to make the rent score more prominent than credit scores and any combination is allowed. Customized score standing values for economic regions and also to a building, complex, city, or regional level is provided.

The developed rent scoring method produces data as in FIG. 4 and can be translated into a landlord's report depicting ratings for all payment related events that occur in the life cycle of a tenancy in a tenancy history payment section of the report sample depicted in FIG. 5.

Standings for rent scoring have a maximum value of 900 and threshold points for the best to the worst scores and can be customized to be increased or decreased depending on economic reasons by geographic region of a country. The standard used by the rent scoring model and program is a score above 730 is very low risk, 700-729 is low risk, 670-699 is medium risk, and 585-669 is high risk and below 584 is very high risk.

Also associated with the rent score is an applicant recommendation derived by software program from Approved, Pre-approved, Conditional, Pre-declined and Declined. Each is associated with the applicable risk standings from very low risk to very high risk.

The acceptance rating system program and method developed to consider the number of times and type of adjudication decision used in conjunction with residence information is a vital component of the rent scoring system, as in FIG. 5 a possible sample of a landlord report format.

For collection activities the rent scoring model is superior to present day collection systems as it considers adjudication results to help locate where a subject debtor resides more accurately and serves a locate notification by email to the landlord under a debtor monitoring program and method.

The rent scoring method and program design only considers tenancy life cycle information however credit information about important negative credit ratings, bankruptcy, fraud related information, law suits and special consumer messages can be inter mingled on the landlord report producing a hybrid. For mass adoption credit scores and all trade and financial credit information is excluded on the landlord report and all trade related to items such items as credit cards, loans, mortgages, and all other payment related items. This condensed format set of credit information in a report form increases personal information security. Optionally credit scores can be used in the rent scoring program hidden in the rent scoring algorithm. Although a full set of credit and tenancy information is always available the level of risk increases with the level of detail requested. In light of this the rent scoring program resultant database information is extremely secure and deliberately undertakes serious consideration for the protection of personal information and privacy rights. With a landlord report format, since tenancy history status does not help to decide a good or bad credit status identity thieves will find that no visible credit information means they cannot use tenancy history information to determine an individual's credit standing required to perpetrate credit card, mortgage or identity fraud.

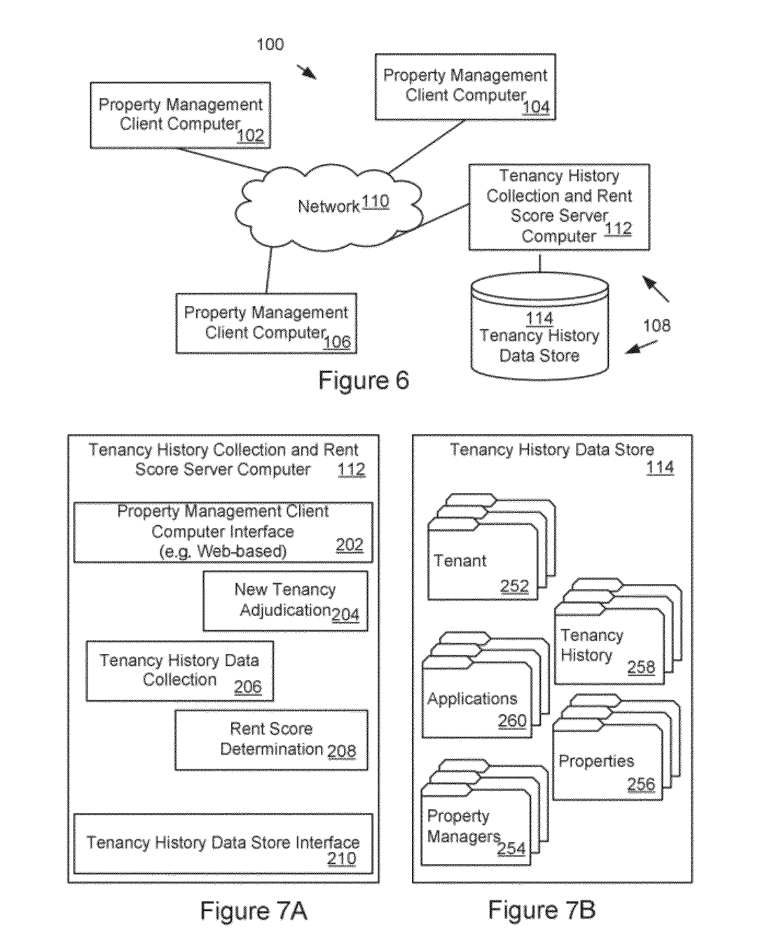

It will be appreciated that the above described tenancy history data collection operations and rent scoring operations may be performed using one or more computing devices such as desktop, laptop, tablet, mobile smartphones, PDAs, servers and other programmed computers. For example, FIG. 6 illustrates an example network communication system 100 including a plurality of property management client computers 102, 104 and 106 are coupled for communication with a tenancy history collection and rent score server system 108 via a network 110 such as the Internet. In this example, tenancy history collection and rent score server system 108 comprises a tenancy history collection and rent score server 112 (server 112) and a tenancy history data store 114 (data store 114). Persons of skill in the art will appreciate that such system 100 is simplified. In general, system 100 is configured as a web-based client server system. Client interfaces to server 112 (e.g. for property management client computers 102, 104 and 106) may be browser-based or native applications configured to present data from server 112, receive user inputs and provide data to server 110.

FIGS. 7A and 7B illustrate components of the example tenancy history collection and rent score server system 108. Server 112 comprises a plurality of components, such as software components stored in a memory (not shown) for configuring the execution of one or more processors (not shown) of server 112. Components comprise a property management client computer interface 202, a new tenancy adjudication 204; tenancy history data collection 206, rent score determination 208 and tenancy history data store interface 210.

Property management client computer interface 202 is configured to communicate with property management client computers 102, 104, 106. New tenancy adjudication 204 component handles new tenancy applications such as receiving new application data and requests to adjudicate the application. Component 204 may be sensitive to prior adjudication requests and be configured to require the input of recent application status, for example, to close the new application and establish an active tenancy to begin on-going history tracking for the respective property or to terminate the application. Tenancy history data collection 206 facilitates history data collection e.g. for active tenancies as described. Component 206 may be configured to add or modify tenancy history data for prior tenancy periods to populate data store 114. Rent score determination 208 calculates rent scores for a tenant such as in association with a new tenancy application or otherwise on demand. Tenancy history data store interface 210 provides an interface to data store 114.

Data store 114 may comprises a persistent store (e.g. memory, hard disk or other storage) such as a database of data. The data may represent tenants 252 (e.g. specific persons such as individuals), property managers 254 (e.g. specific landlords and/or management of properties for rent), properties 256(buildings and units etc. under management and/or for rent to tenants), and tenancy history 258 as described. Tenancy applications 260 may also be stored.

Though not shown, server system 108 may be configured with user accounts (e.g. by property managers, administration, etc.) to provide managed access to the resources of system 108. A property manager may be provided access to open and adjudicate new tenancy applications for properties associated with the property manager. A rent score may be calculated to assist with the adjudication. The rent score is responsive to the tenancy history of the tenant associated to the new application, even if the tenancy history represents events at one or more properties which are not associated to the property manager.

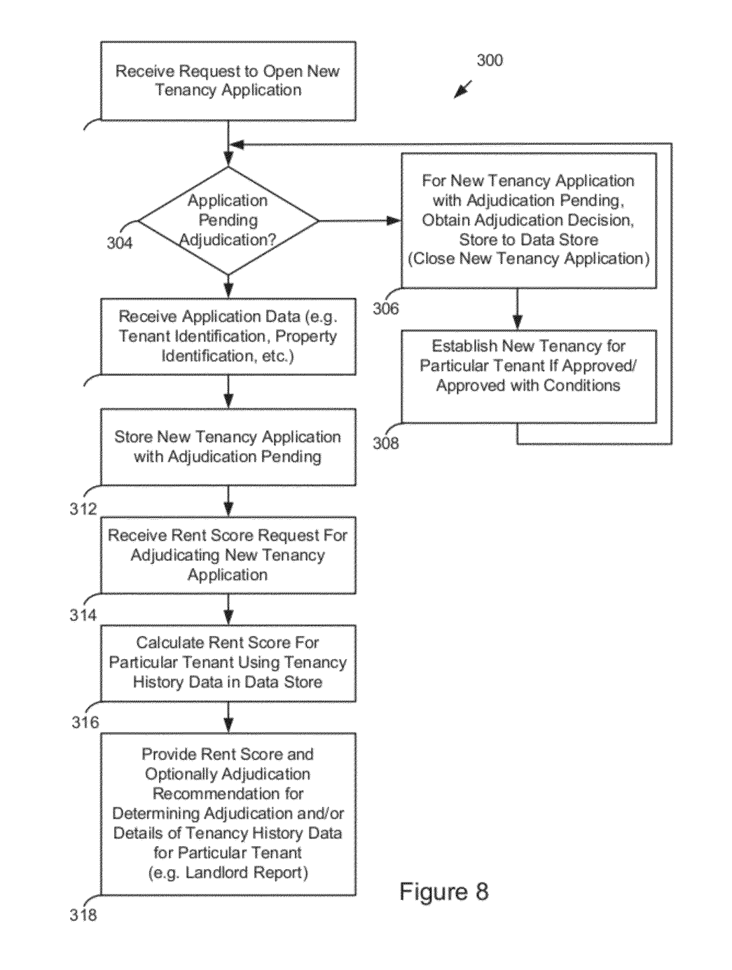

FIG. 8 is a flowchart illustrating operations 300 of the tenancy history collection and rent score server system 108 for processing a new tenancy application including providing a rent score. A new tenancy application request is received (302). If a prior tenancy application remains pending receipt of a decision on whether tenancy was granted (304) operations 300 are configured to require the property manager to provide an update on the decision (306). The receipt of the decision may be used to update the prior application such that it is closed or no longer pending. At 308, a new tenancy for the particular tenant at the particular property can be established according to the decision to ready the gathering of tenancy history data (e.g. until move out). Though not shown, operations 300 may be configured to permit a property manager to hold pending applications and not provide a decision update while a decision is on-going. A set amount of time may be provided (e.g. to allow a manager to defer the new application for later).

At 310, data for a new application is received. This data may comprise identification for the new tenant and property. The property manager may be able to select the tenant 252 and property 256 from data from data store 114 to assist with the new application. At 312 the new application 260 is stored as pending a decision on whether to lease. It is understood that new tenant applications may have one or more checks to ensure that a minimum required information is received. At 314 a rent score request is received and at 316 a rent score is calculated as described above and further below. At 318 operations provide the rent score (e.g. via client interface) and optionally an adjudication recommendation for determining adjudication. Further the operations may provide details of tenancy history data for the particular tenant such as in a Landlord Report (FIGS. 5A and 5B).

The property manager utilizes the rent score and as may be applicable optional recommendation and history to adjudicate the application (determine whether to lease/rent to the applicant). Though not shown, in some embodiments, the new application may be automatically adjudicated in response to the rent score. The new application may be updated accordingly and a new tenancy initiated. In some embodiments, applicable rental documents may be automatically generated (e.g. lease, applicable notices, etc.) to facilitate business and legal obligations between the landlord and tenant.

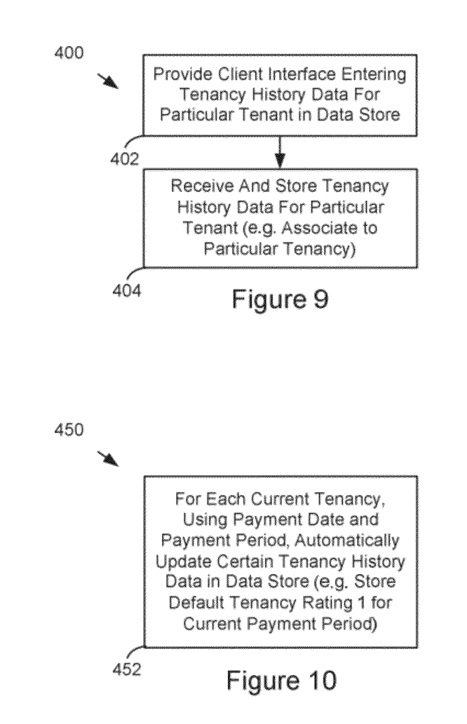

FIG. 9 is a flowchart illustrating operations 400 of the tenancy history collection and rent score server system 108 for receiving tenancy history data 258 from a property management client computer (e.g. 102). A client interface may be provided to receive data representing tenancy events for a particular tenant at a particular property. As noted above in Tables 1 and 2, the event data typically relates to timely or untimely payment status; legal actions (e.g. to terminate tenancy commenced, notice served or legal action filed); making payments under ordered consent or mediated settlement; eviction ordered by judicial decision; sheriffs enforcement, bad debt, placed in collection, skipped; and move out date and reasons.

As a property manager may have many properties under management with many active tenancies and because typically tenants pay on time, system 108 may be configured to automatically update tenancy history payment data, providing property managers an opportunity to opt out of the automatic update or confirm/correct data which is automatically updated. FIG. 10 is a flowchart illustrating operations 450 of the tenancy history collection and rent score server system for automatically updating certain tenancy history payment data. For each current tenancy, using payment date and payment period, system 108 may be configured to automatically update certain tenancy history payment data in data store (e.g. store default tenancy rating 1 for current payment period).

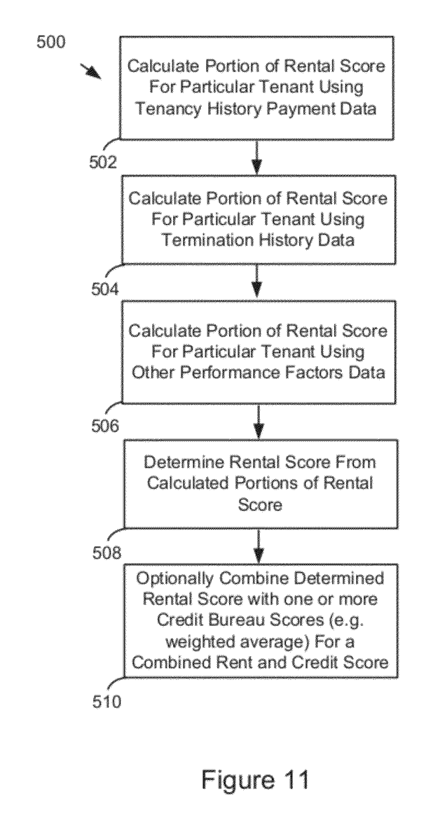

FIG. 11 is a flowchart illustrating operations 500 of the tenancy history collection and rent score server system for calculating rent score for a particular tenant.

### Data Analysis and Scoring

In accordance with one example, when analyzing the collected information in the data store, three (3) categories of characteristics result. These are combined (e.g. in real-time) and a snapshot of the data file condition is calculated for the following.

Tenancy History Payment relates to the payment performance of all manner of housing cost obligations and the outcome of non-payment.

Termination History relates to all manner of reasons and outcome for a resident to vacate a tenancy including good and proper move outs, and grounds and outcome for legal matters associated with a termination.

Other Performance Factors include inquiries and historical leasing decision results, collections, eviction prediction and economic supply and demand metrics.

The total number of event occurrences is treated in a time sensitive point definition manner. The older the event, the lower the point value an occurrence is awarded. An event's point result is the sum of all occurrence points for a sub-total number for a specific event. The point scale, designed for each event, defines its curve, which may be graphed to represent the events over time. Each attribute is charted, graphed and stored for a number of years preset by jurisdiction and legal statutory limitations. These charts and graphs are then further utilized to create least squares polynomial equations for each event. All the existing tenancy life cycle events as in FIG. 1 are then further aggregated and limits are applied, such as 900 to limit the score from expanding too high. Low limits are also defined so that a score of 300 or less means the data is insufficient to be meaningful. Finally, secondary to the rent scoring system, credit information and credit scores from multiple bureaus can be added along with rent scoring using a weighted average method to provide a more complete and in-depth view of an individual's background.

With reference to FIG. 11, at 502, a portion of the rental score is calculated using tenancy history data for the particular tenant in the data store that represents payment history (e.g. how well tenant met the payment obligations). This data is weighted and totaled as described above such that more current events are given more importance within the rental score (e.g. worth more points). A formula may be applied using the event and age to determine the points.

At 504, a portion of the rental score is calculated using tenancy history data for the particular tenant in the data store that represents termination history (e.g. responsive to reason and when tenancy was terminated). This data is weighted and totaled as described above such that more current events are given more importance within the rental score (e.g. worth more points). A formula may be applied using the event and age to determine the points. It is understood that for some events (e.g. events which have a negative impact on tenancy), points may be subtracted (or negative points assigned to the event) from the rent score.

At 506, a portion of the rental score is calculated using tenancy history data for the particular tenant in the data store that represents other performance factors (e.g. responsive to reason and when tenancy was terminated). To the extent the performance factor represents a tenancy history data event (e.g. prior rental inquiries, historical adjudication results, collections), the data may be weighted and totaled as described above such that more current events are given more importance within the rental score (e.g. worth more points). A formula may be applied using the event and age to determine the points.

Some of the other performance factors always represent current events such as income, ratios, eviction prediction, economic supply and demand and thus weighting based on aging may not be necessary.

Rent scoring may be determined from the calculated portions (508). Limits may be applied.

Optionally, the rental score may be combined with credit bureau information and scores (510). Similar scaling may be adopted and a weighted average used to combine two or more such scores.

We claim:

1. A method of adjudicating an application for tenancy made by a particular applicant, the method comprising:
receiving and compiling tenancy history data for a plurality of individual tenants including said particular applicant;
determining a rental score from tenancy history data of the particular applicant, the rental score defining a level of risk associated with renting to the particular applicant;
determining an application recommendation associated with the rental score; and
providing at least one of the rental score and application recommendation for use to determine a final adjudication of the application.

2. The method of claim 1 wherein the tenancy history data for a respective particular tenant comprises tenancy history payment data, termination history data and other performance data.

3. The method of claim 2 wherein the tenancy history data comprises a tenant rating per payment period for a particular property leased by the particular tenant.

4. The method of claim 3 wherein the tenancy history payment data comprises a tenant rating representing payment timeliness during a particular payment period.

5. The method of claim 4 wherein the termination history data comprises a tenant rating representing enforcement of payment or termination during a particular payment period.

6. The method of claim 5 wherein the termination history further includes a move out rating.

7. The method of claim 6 wherein other performance data comprises a tenant rating representing eviction during a particular payment period.

8. The method of claim 7 wherein the tenant rating per payment period is selected from:
0—Not moved in yet, to new to rate or not enough information to rate;
1—On Time or Satisfactory Payment pays within 5 days of Due date;
2—Pays (or paid) within 6 to 30 days or not more than 1 payment past due;
3—Pays (or paid) within 31 to 60 days or not more than 2 payments past due;
4—Pays (or paid) within 61 to 90 days or, 3 or more payments past due;
5—Pays (or paid) within 91 to 120 days but no action filed yet;
6—Legal Action to terminate tenancy commenced, notice served or legal action filed;
7—Making payments under ordered consent or mediated settlement;
8—Eviction Ordered by judicial decision; and
9—Sheriffs Enforcement, Bad Debt, placed in Collection, skipped.

9. The method of claim 3 wherein determining a rental score includes assigning points to the rental score in accordance with the tenancy history payment data, termination history data and other performance data.

10. The method of claim 9 wherein points are assigned in response to the tenant rating in the tenancy history data as a function of time.

11. The method of claim 9 wherein the other performance data comprises one or more of:
eviction data, lease adjudication results data, income data, income to payment ratio data, bankruptcy event data, eviction prediction data, economic supply and demand data.

12. The method of claim 1 further comprising providing credit history information.

13. The method of claim 1 comprising receiving an adjudication request by a requester on behalf of the particular applicant and providing the rental score and application recommendation in response to the request.

14. The method of claim 13 comprising for each request for adjudication, compiling an adjudication result taken by the requester.

15. The method of claim 14 comprising enforcing the providing of the adjudication result by the requester before acting on a subsequent adjudication request by the requester.

16. The method of claim 13 comprising writing a lease in accordance with either the rental score, the application recommendation or both.

17. A system comprising a computer having a processor and a memory coupled thereto and configured with instructions for execution by the processor to perform a method of adjudicating an application for tenancy made by a particular applicant, comprising:
receiving and compiling tenancy history data for a plurality of individual tenants including said particular applicant;
determining a rental score from tenancy history data of the particular applicant, the rental score defining a level of risk associated with renting to the particular applicant;
determining an application recommendation associated with the rental score; and
providing at least one of the rental score and application recommendation for use to determine a final adjudication of the application.

18. The system of claim 17 wherein the tenancy history data for a respective particular tenant comprises tenancy history payment data, termination history data and other performance data.

19. The system of claim 18 wherein the tenancy history data comprises a tenant rating per payment period for a particular property leased by the particular tenant.

20. The system of claim 19 wherein the tenancy history payment data comprises a tenant rating representing payment timeliness during a particular payment period.

21. The system of claim 20 wherein the termination history data comprises a tenant rating representing enforcement of payment or termination during a particular payment period.

22. The system of claim 21 wherein the termination history further includes a move out rating.

23. The system of claim 18 wherein other performance data comprises a tenant rating representing eviction during a particular payment period.

24. The system of claim 23 wherein the tenant rating per payment period is selected from:
0—Not moved in yet, to new to rate or not enough information to rate;
1—On Time or Satisfactory Payment pays within 5 days of Due date;
2—Pays (or paid) within 6 to 30 days or not more than 1 payment past due;
3—Pays (or paid) within 31 to 60 days or not more than 2 payments past due;
4—Pays (or paid) within 61 to 90 days or, 3 or more payments past due;
5—Pays (or paid) within 91 to 120 days but no action filed yet;
6—Legal Action to terminate tenancy commenced, notice served or legal action filed;
7—Making payments under ordered consent or mediated settlement;
8—Eviction Ordered by judicial decision; and
9—Sheriffs Enforcement, Bad Debt, placed in Collection, skipped.

25. The system of claim 19 wherein determining a rental score includes assigning points to the rental score in accordance with the tenancy history payment data, termination history data and other performance data.

26. The system of claim 25 wherein points are assigned in response to the tenant rating in the tenancy history data as a function of time.

27. The system of claim 25 wherein the other performance data comprises one or more of:
eviction data, lease adjudication results data, income data, income to payment ratio data, bankruptcy event data, eviction prediction data, economic supply and demand data.

28. The system of claim 17 wherein the instructions are further configured to provide credit history information.

29. The method of claim 17 wherein the instructions are further configured to receive an adjudication request by a requester on behalf of the particular applicant and providing the rental score and application recommendation in response to the request.

30. The system of claim 29 wherein the instructions are further configured to, for each request for adjudication, compile an adjudication result taken by the requester.

31. The system of claim 30 wherein the instructions are further configured to enforce the providing of the adjudication result by the requester before acting on a subsequent adjudication request by the requester.

32. The system of claim 30 wherein the instructions are further configured to write a lease in accordance with either the rental score, the application recommendation or both.
